(19) United States
(12) Patent Application Publication
(10) Pub. No.: US 2026/0336209 A1
(43) Pub. Date: Oct. 29, 2026

(54) GUIDE RAIL SLIDER FOR 3D PRINTER, 3D PRINTER AND 3D PRINTING SYSTEM

(71) Applicant: SHENZHEN TUOZHU TECHNOLOGY CO., LTD., Shenzhen (CN)

(72) Inventors: Kaiwang TIAN, Shenzhen (CN); Rongming XIONG, Shenzhen (CN)

(21) Appl. No.: 19/700,187

(22) Filed: Jun. 5, 2026

Related U.S. Application Data
(63) Continuation of application No. PCT/CN2024/114716, filed on Aug. 27, 2024.

(30) Foreign Application Priority Data
Dec. 6, 2023 (CN) 202323335465.6

(51) Int. Cl. B29C 64/209; B29C 64/118; B29C 64/232; B29C 64/236; B33Y 30/00

(52) U.S. Cl. CPC B29C 64/209; B29C 64/118; B29C 64/232; B29C 64/236; B33Y 30/00

(57) ABSTRACT

A guide rail slider for a 3D printer includes a slider body, first and second pulleys, a cam, and a first transmission shaft. A limiting boss is fixed on a first surface of the slider body, and the first and second pulleys are arranged on an opposite second surface to clamp two sides of a guide rail. The cam is arranged on the first surface, and a circumferential abutting surface of the cam abuts a side surface of the limiting boss. One end of the first transmission shaft is coaxially connected to the first pulley, and the other end passes through a first limiting hole in the slider body and is coaxially connected to the cam. When the cam rotates, the transmission shaft moves toward or away from the limiting boss, causing the first pulley to move toward or away from the second pulley.

### CROSS-REFERENCE TO RELATED APPLICATION

The present disclosure is a continuation application of International Patent Application No. PCT/CN2024/114716, filed on Aug. 27, 2024, which claims priority to Chinese Patent Application No. 202323335465.6, filed with the China National Intellectual Property Administration on Dec. 06, 2023, and entitled “GUIDE RAIL SLIDER FOR 3D PRINTER, 3D PRINTER, AND 3D PRINTING SYSTEM”, the content of which is incorporated herein by reference in its entirety.

### FIELD

The present disclosure relates to the field of 3D printers, and in particular relates to a guide rail slider for a 3D printer, a 3D printer, and a 3D printing system.

### BACKGROUND

In the process of 3D printing, it is sometimes required that a motor drag a guide rail slider via a timing belt to realize printing in a certain direction. In the process of dragging the guide rail slider, the slider can move along a preset guide rail. Specifically, a plurality of pulleys can be arranged on the guide rail slider, and the plurality of pulleys can be evenly distributed on two sides of the guide rail. When the slider is driven by the timing belt to move, the pulleys on two sides of the guide rail can rotate, such that the guide rail slider can move along the guide rail.

In practical applications, in order to ensure the stability of the movement of the slider, it is necessary to keep the pulleys tightly clamping two sides of the guide rail at all times. Therefore, it is necessary to design the pulleys into adjustable structures. For example, the relative positions of the pulleys on the eccentric wheels and the slider can be adjusted by rotating the eccentric wheels on the slider, such that the pulleys on two sides can clamp the guide rail. However, this adjustment method is not reliable.

### SUMMARY

The present disclosure provides a guide rail slider for a 3D printer. The guide rail slider includes:
a slider body, where a limiting boss is fixedly arranged on a first surface of the slider body;
a first pulley and a second pulley, arranged on a second surface of the slider body, where the first pulley and the second pulley are configured to clamp two sides of a guide rail, and the second surface is opposite to the first surface;
a cam, arranged on the first surface of the slider body, where a rotating shaft of the cam is perpendicular to the first surface, an abutting surface of the cam abuts against a side surface of the limiting boss, and the abutting surface is a circumferential side surface of the cam; and
a first transmission shaft, where one end of the first transmission shaft is coaxially connected to the first pulley, the first transmission shaft passes through a first limiting hole on the slider body, the other end of the first transmission shaft is coaxially connected to the cam, and an area of the first limiting hole is greater than a cross-sectional area of the first transmission shaft; a direction between the limiting boss and the cam is in a same direction as a direction between the first pulley and the second pulley; the rotating shaft of the cam moves away from or close to the limiting boss when the cam rotates, such that the first pulley coaxially connected to the cam moves close to or away from the second pulley.

With reference to the first aspect, in a first possible implementation, the first limiting hole is an elongated hole, and a length direction of the elongated hole is in a same direction as a direction between the first pulley and the second pulley.

In the embodiments of the present disclosure, when a user rotates the cam, the first transmission shaft can move in the first limiting hole, such that the first pulley moves close to or away from the second pulley.

With reference to the first aspect or any one of the foregoing possible implementations, in a second possible implementation, the side surface of the limiting boss for abutting against the abutting surface is perpendicular to the first surface.

In the embodiments of the present disclosure, the side surface of the limiting boss is perpendicular to the first surface of the slider body.

With reference to the first aspect or any one of the foregoing possible implementations, in a third possible implementation, the side surface of the limiting boss for abutting against the abutting surface is parallel to the rotating shaft of the cam.

With reference to the first aspect or any one of the foregoing possible implementations, in a fourth possible implementation, the limiting boss is located on a side, away from the second pulley, of the cam.

With reference to the first aspect or any one of the foregoing possible implementations, in a fifth possible implementation, the guide rail slider further includes: a first limiting member, detachably connected to the slider body and configured to fix the cam to the slider body to prevent the cam from rotating.

With reference to the first aspect or any one of the foregoing possible implementations, in a sixth possible implementation, the first limiting member includes a screw, a rocker arm is arranged on one side of the cam, a second limiting hole is provided at an end, away from the rotating shaft of the cam, of the rocker arm, and an area of the second limiting hole is greater than a cross-sectional area of the screw; a first screw hole corresponding to the screw is provided on the slider body, and the screw is configured to pass through the second limiting hole and the first screw hole to fix the cam by fixing the rocker arm.

With reference to the first aspect or any one of the foregoing possible implementations, in a seventh possible implementation, the rocker arm and the abutting surface are located on two sides of the cam, respectively.

With reference to the first aspect or any one of the foregoing possible implementations, in an eighth possible implementation, the second limiting hole is a strip-like hole, and a length direction of the strip-like hole is perpendicular to a radial direction of the cam.

With reference to the first aspect or any one of the foregoing possible implementations, in a ninth possible implementation, the first screw hole includes a first sub-screw hole and a second sub-screw hole; when the cam rotates to a first angle, the screw is configured to pass through the second limiting hole and the first sub-screw hole; when the cam rotates to a second angle, the screw is configured to pass through the second limiting hole and the second sub-screw hole.

In a second aspect, the embodiments of the present disclosure provide a 3D printer. The 3D printer includes the guide rail slider with reference to the first aspect or with reference to any one of the above possible implementations of the first aspect, a guide rail, a print table, a driving apparatus, and a base, where

the guide rail slider is connected to the print table, the base is fixedly connected to the guide rail, the guide rail is slidably connected to the guide rail slider, and the driving apparatus is configured to drive a relative displacement between the guide rail slider and the guide rail, so as to drive a relative displacement between the print table and the guide rail.

In a third aspect, the embodiments of the present disclosure provide a 3D printing system. The 3D printing system includes a feeding device and the 3D printer with reference to the second aspect, where the feeding device is configured to provide a filament to the 3D printer.

### BRIEF DESCRIPTION OF THE DRAWINGS

FIG. 1 is a schematic diagram of a scenario of a 3D printing system according to an embodiment of the present disclosure;

FIG. 2a is a schematic diagram of a three-dimensional structure of a guide rail slider according to an embodiment of the present disclosure;

FIG. 2b is a schematic diagram of a three-dimensional structure of a guide rail slider according to an embodiment of the present disclosure;

FIG. 2c is a schematic diagram of a three-dimensional structure of a guide rail slider according to an embodiment of the present disclosure;

FIG. 2d is a schematic diagram of a three-dimensional structure of a guide rail slider according to an embodiment of the present disclosure;

FIG. 2e is a schematic diagram of a three-dimensional structure of a guide rail slider according to an embodiment of the present disclosure; and

FIG. 3 is a schematic diagram of a planar structure of a cam according to an embodiment of the present disclosure.

### DETAILED DESCRIPTION

Implementations of the technical solutions of the present disclosure are further described in detail below with reference to the accompanying drawings.

The connection includes a detachable connection and a non-detachable connection. For example, the fixed connection may include a detachable fixed connection and a non-detachable fixed connection, the rotational connection may include a detachable rotational connection and a non-detachable rotational connection, and the sliding connection may include a detachable sliding connection and a non-detachable sliding connection. Likewise, the connection may also be a direct connection or an indirect connection via a component. For example, in the case of a detachable fixed connection, it means that in the mounted state, the positional relationship between at least two connected objects can be fixed; similarly, there are rotational connections, sliding connections, etc.

In addition, the terms “first”, “second”, and the like are only for description, and may not be construed as indicating or implying the relative importance or implicitly indicating the number or order of the technical features denoted. Thus, features defined by “first” and “second” may explicitly or implicitly include one or more of the features.

The terms “parallel”, “perpendicular”, and “same direction” are defined for the current state of the art, rather than being absolutely rigid definitions in a mathematical sense, allowing for a small amount of deviation. For example, A being parallel to B means that A and B are parallel or approximately parallel, and the included angle between A and B may be between 0° and 10°. For another example, A being perpendicular to B means that A and B are perpendicular or approximately perpendicular, and the included angle between A and B may be between 80° and 100°. For another example, A and B being in the same direction means that A and B are parallel or approximately parallel, and the included angle between A and B may be between 0° and 10°.

Spatially relative terms, such as “under”, “beneath”, “lower”, “below”, “on top of”, and “upper”, may be used herein to describe the relationship between one element or feature and another element(s) or feature(s) shown in the figures. It will be understood that, these spatially relative terms are intended to encompass different orientations of a device in use or operation in addition to the orientation depicted in the figure. For example, if the device in the figure is turned over, an element described as “beneath another element or feature” or “under another element or feature” or “below another element or feature” will then be oriented as “on top of another element or feature”. Thus, exemplary terms “beneath” and “below” may encompass both orientations “on top of” and “beneath”. Similarly, terms such as “before” or “prior to” and “after” or “next” may be used, for example, to indicate the order in which light passes through elements. The device may be otherwise oriented (rotated 90 degrees or at other orientations), and the spatially relative descriptors used herein are construed accordingly.

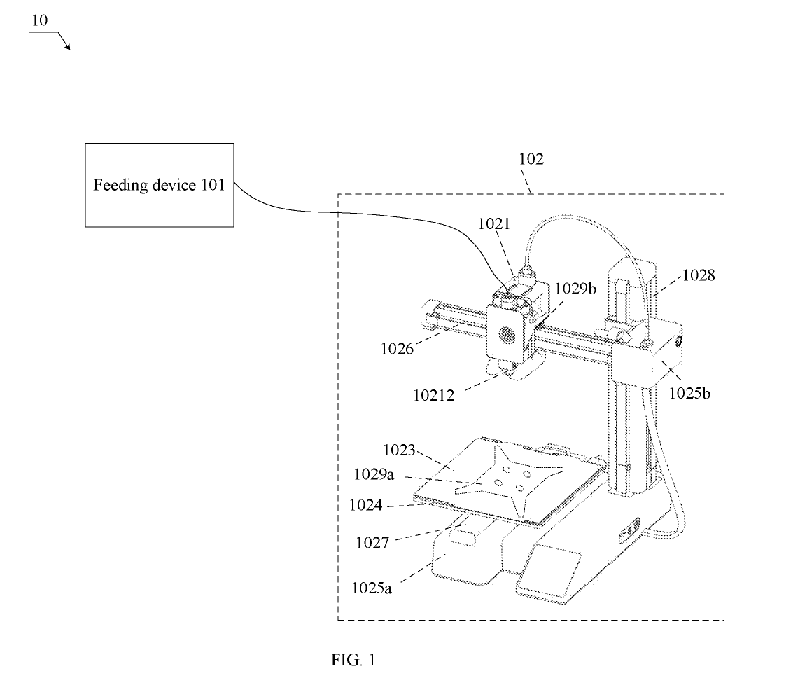

Referring to FIG. 1, FIG. 1 is a schematic diagram of a scenario of a 3D printing system according to an embodiment of the present disclosure. As shown in FIG. 1, the 3D printing system 10 includes a feeding device 101 and a 3D printer 102. The feeding device 101 is configured to provide a filament to the 3D printer.

The feeding device 101 may hang a filament spool, and a printing material (filament) is wound around the filament spool. The feeding device 101 may provide the printing material to the 3D printer 102. In one embodiment, the printing material may be rewound onto the filament spool through the feeding device 101. That is, the feeding device 101 can feed or retract materials. Illustratively, the feeding device 101 may also identify the material information of the printing material and send the material information of the printing material to the 3D printer 102.

The 3D printer 102 includes a printing head 1021, where the printing head 1021 includes a hot end 10212 and an extrusion assembly. During the feeding process of the feeding device 101, the printing material passes through the extrusion assembly, and the extrusion assembly provides the printing material to the hot end 10212. During the retracting process of the feeding device 101, the 3D printer 102 cuts off the printing material in the printing head 1021, and the extrusion assembly conveys the printing material to the feeding device 101.

Optionally, the 3D printer 102 may, for example, cut off the printing material between the extrusion assembly and the hot end 10212, or cut off the printing material within the extrusion assembly. The position where the 3D printer cuts off the printing material is not limited in the present disclosure.

Illustratively, the 3D printer 102 further includes a print panel 1023, a heated bed 1024, a base 1025a, and a guide rail slider 1029a. The heated bed 1024 is arranged on a side, facing a nozzle of the hot end 10212, of the base 1025a, and the heated bed 1024 has a heating function. The print panel 1023 is arranged on a side, facing the nozzle of the hot end 10212, of the heated bed 1024, the heat of the heated bed 1024 can be conducted to the print panel 1023, and the nozzle of the hot end 10212 can extrude a printing material in a molten state onto the print panel 1023. Optionally, the 3D printer 102 further includes a seat 1025b and a slider 1029b. The print panel 1023 and the heated bed 1024 may form a print table.

In a specific implementation, the 3D printer may adjust the temperatures of the hot end 10212 and the heated bed 1024. The 3D printer adjusts the temperature of the hot end 10212 to heat the printing material to a molten state, and adjusts the temperature of the heated bed 1024 to adhere the printing material extruded from the nozzle of the hot end 10212 to the print panel 1023. The printing head 1021 is slidably connected to a first guide rail 1026. The printing head 1021 can move along a length direction of the first guide rail 1026; that is, the displacement of the printing head 1021 relative to the print panel 1023 along the length direction of the first guide rail 1026 is achieved. Moreover, the heated bed 1024 is directly or indirectly connected to the guide rail slider 1029a. For an indirect connection, for example, the guide rail slider 1029a may be fixedly connected to a heated bed support, then elastically or fixedly connected to the heated bed via the heated bed support, and the heated bed is slidably connected to a second guide rail 1027 through the sliding connection between the guide rail slider 1029a and the second guide rail 1027. The heated bed 1024 moves along a length direction of the second guide rail 1027; that is, the displacement of the printing head 1021 relative to the print panel 1023 along the length direction of the second guide rail 1027 is achieved. The length direction of the second guide rail 1027 is perpendicular to the length direction of the first guide rail 1026. Moreover, the first guide rail 1026 is slidably connected to a third guide rail 1028, and the 3D printer 102 can achieve the displacement of the printing head 1021 relative to the print panel 1023 in a direction perpendicular to the length of the second guide rail 1027 and a direction perpendicular to the length of the first guide rail 1026 by moving the first guide rail 1026 along the third guide rail 1028. That is, the 3D printer 102 can implement three printing paths in three mutually perpendicular directions, thereby printing three-dimensional objects. A driving apparatus may be used to drive a relative displacement between the guide rail slider 1029a and the second guide rail 1027. One, two, or three third guide rails 1028 may be provided. The guide rail may be a guide rail corresponding to the guide rail slider, or may be a lead screw or a combination of a lead screw and a linear shaft.

In one possible implementation, the driving apparatus may include a timing belt, at least one timing pulley, and a motor coaxially connected to or in transmission connection with one of the timing pulleys.

In the embodiments of the present disclosure, a cam and a limiting boss are provided with respect to a pulley. Through a fixed position of the limiting boss, the cam does not shift, thereby making the structure more reliable. In addition, this method features a simple structure, resulting in low cost and convenient processing.

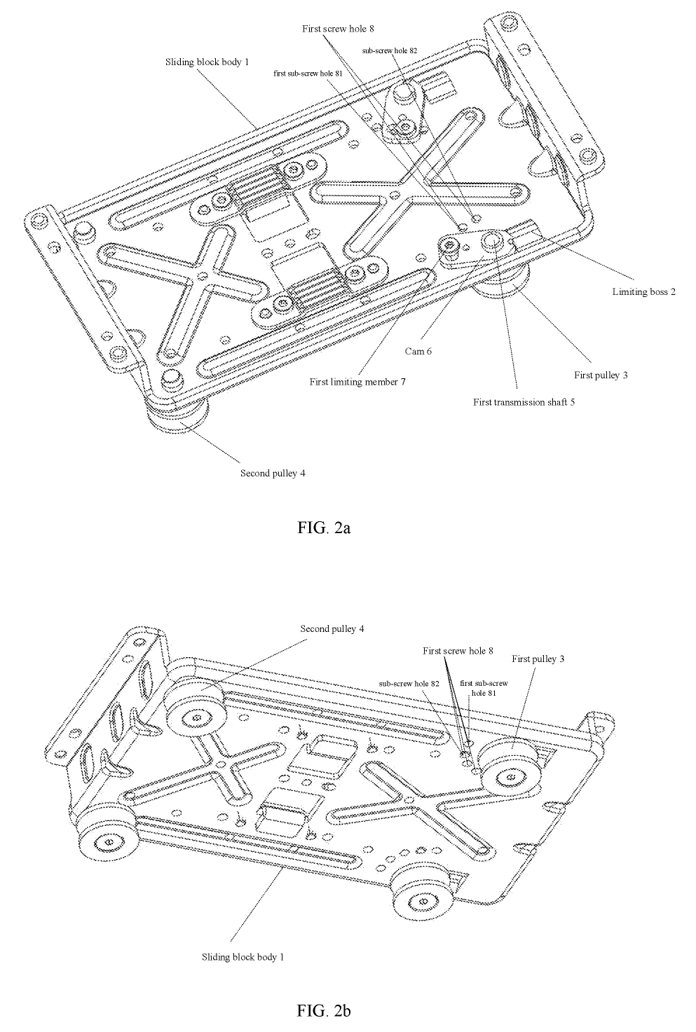

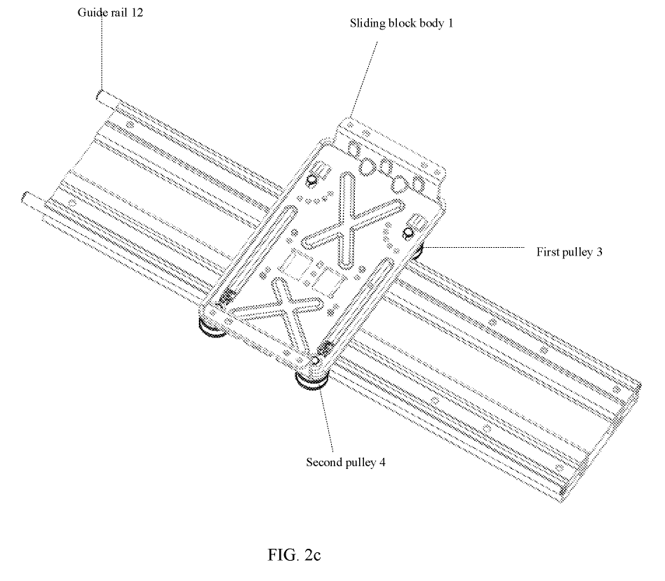

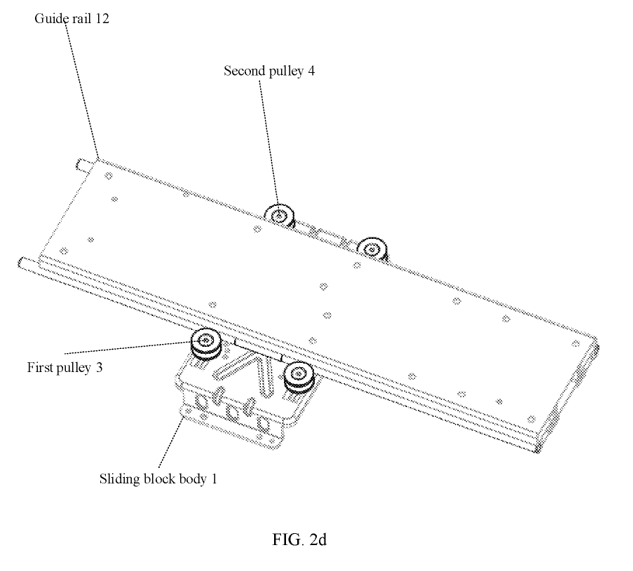

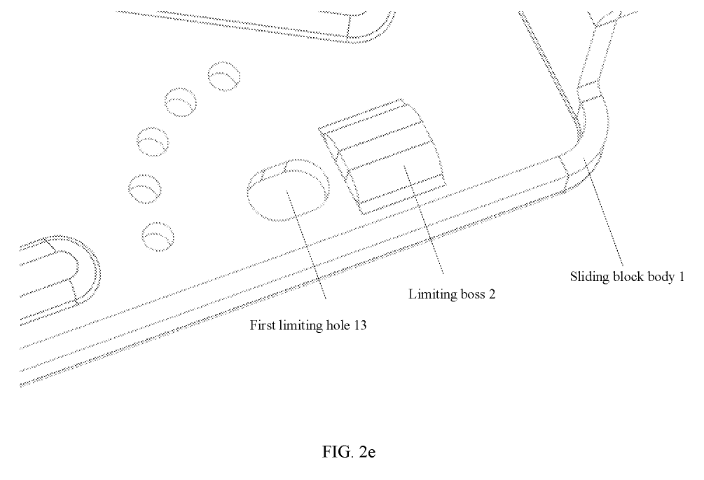

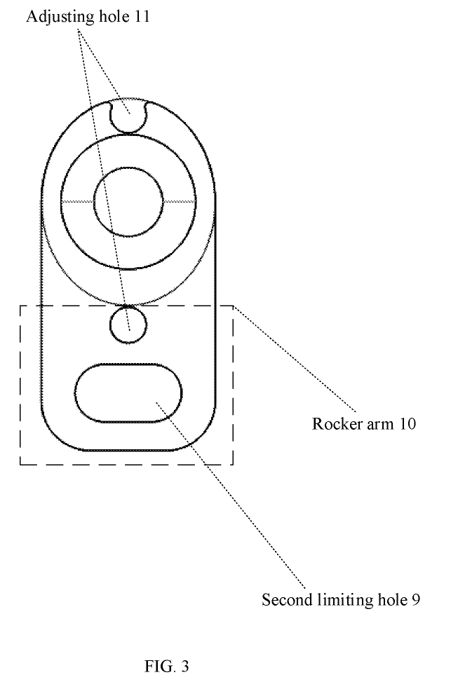

The structure of the guide rail slider will be described in detail with reference to FIGS. 2a to 3.

Referring to FIGS. 2a and 2b, FIG. 2a is a schematic diagram of a three-dimensional structure of a guide rail slider from an angle of view according to an embodiment of the present disclosure, and FIG. 2b is a schematic diagram of a three-dimensional structure of a guide rail slider from another angle of view according to an embodiment of the present disclosure.

The guide rail slider may include:
a slider body 1, where a limiting boss 2 is fixedly arranged on a first surface of the slider body;
a first pulley 3 and a second pulley 4, arranged on a second surface of the slider body 1, where the first pulley 3 and the second pulley 4 are configured to clamp two sides of a guide rail 12, and the second surface is opposite to the first surface;
a cam 6, arranged on the first surface of the slider body 1, where a rotating shaft of the cam 6 is perpendicular to the first surface, an abutting surface of the cam 6 abuts against a side surface of the limiting boss 2, and the abutting surface is a circumferential side surface of the cam 6; and
a first transmission shaft 5, where one end of the first transmission shaft is coaxially connected to the first pulley 3, the first transmission shaft 5 passes through a first limiting hole 13 on the slider body, the other end of the first transmission shaft 5 is coaxially connected to the cam 6, and an area of the first limiting hole 13 is greater than a cross-sectional area of the first transmission shaft 5; a direction between the limiting boss 2 and the cam 6 is in the same direction as a direction between the first pulley 3 and the second pulley 4; the rotating shaft of the cam 6 moves away from or close to the limiting boss 2 when the cam 6 rotates, such that the first pulley 3 coaxially connected to the cam 6 moves close to or away from the second pulley 4.

In one embodiment, the first limiting hole 13 may be an arc-shaped hole, or a circular through-hole, or an elongated hole, and the region of the first limiting hole 13 is the movement region of the first transmission shaft.

Illustratively, the guide rail slider may be connected to a timing belt, and the timing belt, when moving, may drive the guide rail slider to move. The guide rail slider may be slidably connected to a preset guide rail, and the guide rail slider, when moving, may move according to the trajectory of the preset guide rail 12. As a result, the guide rail slider can stably move back and forth in one direction along the guide rail 12, as shown in FIG. 2c.

The guide rail slider may be connected to the heated bed or the printing head of the 3D printer to drive the heated bed (or the print table) or the printing head to move, which is not limited in the embodiments of the present disclosure.

In some feasible implementations, the guide rail slider may include a slider body 1 and pulleys arranged on the slider body 1. Specifically, a first pulley 3 and a second pulley 4 that are configured to clamp two sides of the guide rail 12 may be arranged on a second surface of the slider body 1. The first pulley 3 and the second pulley 4 clamp two sides of the guide rail 12, such that the slider body 1 can be slidably connected to the guide rail through the first pulley 3 and the second pulley 4, as shown in FIG. 2d. The first pulley 3 and the second pulley 4 may be U-shaped bearings. Specifically, the first pulley 3 may be a first U-shaped bearing, and the second pulley 4 may be a second U-shaped bearing. The guide rail 12 may be a double-axis guide rail, which is not limited in the embodiments of the present disclosure.

The guide rail slider may further include a cam 6 arranged on a first surface opposite to the second surface of the slider body 1. A rotating shaft of the cam 6 may be perpendicular to the first surface of the slider body 1, and the cam 6 may be connected to the first pulley 3 through a first transmission shaft 5. Illustratively, the cam 6 may be cylindrical or elliptical cylindrical (an elliptical cylindrical cam may be shown in FIG. 2b). When the cam 6 is cylindrical, the rotating shaft of the cam 6 may be located at a non-circular center position. When the cam 6 is elliptical cylindrical, the rotating shaft of the cam 6 may be located at a symmetric center position or a non-symmetric center position, which is not limited in the embodiments of the present disclosure.

Illustratively, the first transmission shaft 5 may be a screw, in one embodiment, a bearing screw. To ensure that the screw hole corresponding to the screw has a thread of a sufficient length, the screw hole corresponding to the screw may be designed as a flanged structure, and the flange is arranged outward from the screw hole.

Specifically, one end of the first transmission shaft 5 may be coaxially connected to the first pulley 3, and the other end of the first transmission shaft 5 may pass through the first limiting hole 13 provided on the slider body 1 and be coaxially connected to the cam 6. By rotating the cam 6, the first pulley 3 can be driven to move.

In some feasible embodiments, a limiting boss 2 is further arranged on the first surface of the slider body 1. A side surface of the limiting boss 2 can abut against the circumferential side surface of the cam 6, and a direction of a connecting line between the limiting boss 2 and the cam 6 is the same as a direction of a connecting line between the first pulley 3 and the second pulley 4.

Based on the above structure, when the cam 6 rotates, due to the arrangement of the rotating shaft position and the abutting effect of the circumferential side surface against the limiting boss 2, the rotating shaft of the cam 6 will move away from or close to the limiting boss 2. In this case, the first transmission shaft 5 coaxially connected to the cam 6 will move in the first limiting hole 13 with an area greater than the cross-sectional area of the first transmission shaft 5. Further, the moving first transmission shaft 5 will drive the first pulley 3 coaxially connected to the other end of the first transmission shaft to move. When the second pulley 4 does not move, for the moving first pulley 3, the first pulley 3 will move close to or away from the second pulley 4. When the first pulley 3 moves close to the second pulley 4, the pulley and the guide rail 12 can be tensioned.

In one embodiment of the present disclosure, the first limiting hole 13 is an elongated hole, and a length direction of the elongated hole is in the same direction as the direction between the first pulley and the second pulley, as shown in FIG. 2e.

In some feasible implementations, the first limiting hole 13 may be an elongated hole, and the length direction of the elongated hole may be in the same direction as the direction of the connecting line between the first pulley and the second pulley. Therefore, when moving in the elongated hole, the first transmission shaft can move back and forth in the direction of the connecting line between the first pulley and the second pulley, thereby driving the first pulley to move close to or away from the second pulley.

In one embodiment of the present disclosure, the side surface of the limiting boss for abutting against the abutting surface is perpendicular to the first surface. Specifically, the side surface of the limiting boss for abutting against the circumferential side surface of the cam is also perpendicular to the first surface.

As an example, the side surface of the limiting boss for abutting against the abutting surface is parallel to the rotating shaft of the cam. In one embodiment, the side surface of the limiting boss for abutting against the circumferential side surface of the cam may also be parallel to the rotating shaft of the cam perpendicular to the first surface.

As an example, the limiting boss is located on a side, away from the second pulley, of the cam.

In one embodiment of the present disclosure, the guide rail slider further includes: a first limiting member 7 (referring to FIG. 2a), detachably connected to the slider body and configured to fix the cam to the slider body to prevent the cam from rotating.

In some feasible implementations, after the position of the first pulley is adjusted, to avoid insufficient tension of the first pulley and the second pulley on the guide rail 12 caused by rotation of the cam or self-loosening of the first pulley, a first limiting member 7 may be further arranged on the guide rail slider, and the first limiting member 7 is detachably connected to the slider body. When the first limiting member 7 is connected to the slider body, the cam can be fixed to the slider body, so as to prevent the cam from rotating, which may otherwise lead to displacement of the first pulley. When the first limiting member 7 is separated from the slider body, the cam may be rotated, so as to adjust the position of the first pulley.

In one embodiment of the present disclosure, the first limiting member 7 includes a screw, a rocker arm is arranged on one side of the cam, a second limiting hole is provided at an end, away from the rotating shaft of the cam, of the rocker arm, and an area of the second limiting hole is greater than a cross-sectional area of the screw; a first screw hole corresponding to the screw is provided on the slider body, and the screw is configured to pass through the second limiting hole and the first screw hole to fix the cam by fixing the rocker arm. The first screw hole is located within a range of the second limiting hole. Since the area of the second limiting hole is greater than the cross-sectional area of the screw, the area of the second limiting hole is greater than an area of the first screw hole, such that the cam can still be fixed while being capable of rotating within a specific range.

In some feasible implementations, as shown in FIG. 3, a rocker arm 10 may be arranged on one side of the cam 6. When the cam 6 needs to be adjusted, the position of the rocker arm 10 may be adjusted to enable the cam 6 to rotate. A second limiting hole 9 may be provided on the rocker arm 10, and a first screw hole 8 corresponding to the screw is provided on the slider body. When the cam 6 needs to be fixed, the first limiting member 7 can pass through the second limiting hole 9 and the first screw hole 8. Specifically, there may be a thread in the first screw hole 8, and the first limiting member 7 passes through the second limiting hole 9 and is in threaded connection with the first screw hole 8. Alternatively, there may be no thread in the first screw hole 8, and the first limiting member 7 passes through the second limiting hole 9 and the first screw hole 8 and is in threaded connection with a nut.

The rocker arm may be a part of the cam, or may be independent of the cam and fixedly connected to the cam.

The first limiting member 7 may include a screw. When the cam 6 needs to be fixed, the screw may pass through the second limiting hole 9 and the first screw hole 8 to fix the cam 6, which is not limited in the embodiments of the present disclosure.

As an example, the second limiting hole 9 on the rocker arm 10 may be provided at the end, away from the rotating shaft of the cam 6, of the rocker arm 10, and the area of the second limiting hole 9 may be greater than the cross-sectional area of the screw.

In one embodiment of the present disclosure, the rocker arm 10 and the abutting surface are located on two sides or two ends of the cam 6, respectively. Specifically, the rocker arm 10 may be on one side of the cam 6, and the abutting surface may be on the other side of the cam 6.

In one embodiment of the present disclosure, the second limiting hole is a strip-like hole, and a length direction of the strip-like hole is perpendicular to a radial direction of the cam. Specifically, the second limiting hole may be a strip-like hole in a strip shape, as shown in FIG. 3, and the length direction of the strip-like hole is perpendicular to the radial direction of the cam. Optionally, the second limiting hole may also be an arc-shaped hole, which is also perpendicular to the radial direction of the cam, and the second limiting hole may also be a round hole with a relatively large area.

In one embodiment of the present disclosure, the first screw hole 8 includes a first sub-screw hole 81 and a second sub-screw hole 82; when the cam rotates to a first angle, the screw is configured to pass through the second limiting hole and the first sub-screw hole; when the cam rotates to a second angle, the screw is configured to pass through the second limiting hole and the second sub-screw hole.

In some feasible implementations, the first screw hole 8 may include a first sub-screw hole 81 and a second sub-screw hole 82 that are arranged at different positions of the slider body, as shown in FIGS. 2a and 2b.Any one of the sub-screw holes may serve as the first sub-screw hole 81, and another sub-screw hole at a different angle may serve as the second sub-screw hole 82. The reference numerals 81 and 82 shown in FIGS. 2a and 2b are merely illustrative and do not limit the sub-screw holes to two specific holes. When the cam is rotated to the first angle, the cam may be fixed based on the first sub-screw hole. Specifically, the screw may pass through the second limiting hole and the first sub-screw hole to fix the cam to the slider body.

When the cam is rotated to the second angle, the cam may be fixed based on the second sub-screw hole. Specifically, the screw may pass through the second limiting hole and the second sub-screw hole to fix the cam to the slider body.

In one embodiment, the direction of a connecting line of the two sub-screw holes is perpendicular to the radial direction of the cam. Such a design provides a larger angle adjustment range for the cam. Further, the first screw hole may include a plurality of sub-screw holes, and a connecting line of the plurality of sub-screw holes may be arc-shaped and perpendicular to the radial direction of the cam. At least one sub-screw hole of the first screw hole is located within the range of the second limiting hole. Since the area of the second limiting hole is greater than the cross-sectional area of the screw, the area of the second limiting hole is greater than an area of the at least one sub-screw hole of the first screw hole, and the cam can still be fixed while being capable of rotating within a specific range.

In another embodiment of the present disclosure, the first screw hole itself may also be an arc-shaped screw hole, and a movement path of the arc-shaped screw hole is consistent with that of the second limiting hole. When the cam is rotated, the second limiting hole is also displaced, and the displaced second limiting hole is still in communication with the first screw hole. Therefore, the screw can be inserted to fix the cam to the slider body.

In one embodiment of the present disclosure, as shown in FIG. 3, an adjusting hole 11 may also be provided on the cam 6, and the adjusting hole is located in a region other than the rotating shaft of the cam. The cam can be rotated through the adjusting hole 11. For example, an adjusting tool may be inserted into the adjusting hole 11, and the cam is rotated by the adjusting device inserted into the adjusting hole 11. The adjusting tool may be, for example, a hex key, a screwdriver, or another tool capable of rotating the cam through the adjusting hole.The position of the adjusting hole 11 may be set according to actual situations, which is not limited in the embodiments of the present disclosure.

The terms “first” and “second” described above are used for descriptive purposes only and are not to be construed as indicating or implying relative importance.

What is claimed is:

1. A guide rail slider for a 3D printer, wherein the guide rail slider comprises:
a slider body, wherein a limiting boss is fixedly arranged on a first surface of the slider body;
a first pulley and a second pulley, arranged on a second surface of the slider body, wherein the first pulley and the second pulley are configured to clamp two sides of a guide rail, and the second surface is opposite to the first surface;
a cam, arranged on the first surface of the slider body, wherein an abutting surface of the cam abuts against a side surface of the limiting boss, and the abutting surface is a circumferential side surface of the cam; and
a first transmission shaft, wherein one end of the first transmission shaft is coaxially connected to the first pulley, the other end of the first transmission shaft is coaxially connected to the cam after passing through a first limiting hole arranged on the slider body, the first transmission shaft is perpendicular to the first surface, and an area of the first limiting hole is greater than a cross-sectional area of the first transmission shaft; an arrangement direction of the limiting boss and the cam is in a same direction as an arrangement direction of the first pulley and the second pulley; when the cam rotates, the first transmission shaft moves away from or close to the limiting boss, such that the first pulley coaxially connected to the cam moves close to or away from the second pulley.

2. The guide rail slider according to claim 1, wherein when the cam rotates, the first transmission shaft slides in the first limiting hole, such that the first pulley coaxially connected to the cam moves close to or away from the second pulley.

3. The guide rail slider according to claim 1, wherein the first limiting hole is an elongated hole, and a length direction of the elongated hole is in a same direction as the arrangement direction of the first pulley and the second pulley.

4. The guide rail slider according to claim 1, wherein the side surface of the limiting boss abutting against the abutting surface of the cam is perpendicular to the first surface.

5. The guide rail slider according to claim 1, wherein the side surface of the limiting boss abutting against the cam is parallel to the first transmission shaft.

6. The guide rail slider according to claim 1, wherein the limiting boss is located on a side, away from the second pulley, of the cam.

7. The guide rail slider according to claim 1, wherein an adjusting hole is provided on the cam, and the adjusting hole is located in a region other than a region occupied by the first transmission shaft for an adjusting tool to be inserted to rotate the cam.

8. The guide rail slider according to claim 1, wherein the guide rail slider further comprises: a first limiting member, the first limiting member being detachably connected to the slider body and configured to fix the cam to the slider body to prevent the cam from rotating.

9. The guide rail slider according to claim 8, wherein the first limiting member comprises a screw, a rocker arm is arranged on one side of the cam, a second limiting hole is provided at one end, away from the first transmission shaft, of the rocker arm, and an area of the second limiting hole is greater than a cross-sectional area of the screw; a first screw hole corresponding to the screw is provided on the slider body, and the screw is configured to pass through the second limiting hole and cooperate with the first screw hole to fix the cam to the slider body by fixing the rocker arm.

10. The guide rail slider according to claim 9, wherein the rocker arm and the abutting surface are located on two opposite sides of the cam, respectively.

11. The guide rail slider according to claim 9, wherein
the second limiting hole is a strip-like hole, and a length direction of the strip-like hole is perpendicular to a radial direction of the cam.

12. The guide rail slider according to claim 9, wherein
the first screw hole comprises a first sub-screw hole and a second sub-screw hole; when the cam rotates to a first angle, the screw is configured to pass through the second limiting hole and cooperate with the first sub-screw hole; when the cam rotates to a second angle, the screw is configured to pass through the second limiting hole and cooperate with the second sub-screw hole, the first angle being different from the second angle.

13. The guide rail slider according to claim 12, wherein the first sub-screw hole and the second sub-screw hole are distributed in an arc shape.

14. The guide rail slider according to claim 12, wherein a direction of a connecting line between the first sub-screw hole and the second sub-screw hole is perpendicular to the radial direction of the cam.

15. A 3D printer, comprising a guide rail slider, a guide rail, a print table, a driving apparatus, and a base, wherein
the guide rail slider comprises: a slider body, wherein the slider body is provided with a first surface and a second surface opposite to the first surface, and a limiting boss is fixedly arranged on the first surface;
a first pulley and a second pulley, arranged on the second surface and configured to clamp the guide rail;
a cam, arranged on the first surface, wherein an abutting surface of the cam abuts against a side surface of the limiting boss, and the abutting surface is a circumferential side surface of the cam; and
a first transmission shaft, wherein one end of the first transmission shaft is coaxially connected to the first pulley, the other end of the first transmission shaft is coaxially connected to the cam after passing through a first limiting hole arranged on the slider body, the first transmission shaft is perpendicular to the first surface, and an area of the first limiting hole is greater than a cross-sectional area of the first transmission shaft; an arrangement direction of the limiting boss and the cam is in a same direction as an arrangement direction of the first pulley and the second pulley; when the cam rotates, the first transmission shaft moves away from or close to the limiting boss, such that the first pulley coaxially connected to the cam moves close to or away from the second pulley;
the guide rail is fixedly connected to the base, the guide rail slider is connected to the print table and slidably connected to the guide rail, and the driving apparatus is configured to drive a relative displacement between the guide rail slider and the guide rail, so as to drive a relative displacement between the print table and the guide rail.

16. A 3D printing system, comprising a feeding device and the 3D printer according to claim 15, wherein the feeding device is configured to provide a filament to the 3D printer.
